(19) United States
(12) Patent Application Publication
(10) Pub. No.: US 2010/0283912 A1
(43) Pub. Date: Nov. 11, 2010

(54) Apparatus for Demodulating Digital Video and Associated Method

(75) Inventors: Shan-Cheng Sun, Hsinchu Hsien (TW); Chien-Jen Hung, Hsinchu Hsien (TW); Jiun-Ren Wang, Hsinchu Hsien (TW); Tai-Lai Tung, Hsinchu Hsien (TW)

Correspondence Address: LEE & HAYES, PLLC, 601 W. RIVERSIDE AVENUE, SUITE 1400, SPOKANE, WA, 99201, US

(73) Assignee: MSTAR SEMICONDUCTOR, INC., Hsinchu Hsien (TW)

(21) Appl. No.: 12/767,396

(22) Filed: Apr. 26, 2010

Related U.S. Application Data
(60) Provisional application No. 61/176,494, filed on May 8, 2009.

(51) Int. Cl. H04N 5/455; H04L 27/06

(52) U.S. Cl. 348/726; 375/340; 348/E05.096

(57) ABSTRACT

An apparatus for demodulating a digital video signal applied to a receiving end of an Orthogonal Frequency-Division Multiplexing (OFDM) communication system is provided. The apparatus receives a plurality of OFDM symbols, and stores a plurality of data sequences in an external memory. The apparatus includes a de-interleaver, that de-interleaves the data sequences to generate a plurality of de-interleaved data sequences; a decoder, coupled to the de-interleaver, that generates a plurality of data streams according to the de-interleaved data sequences; a reconstruction apparatus, coupled to the decoder, that reconstructs the data streams into a transport stream; and a memory interface unit, coupled to the external memory, that accesses the data sequences and the data streams from the external memory. The external memory includes a de-interleaving buffer that stores the data sequence, and a data reconstructing buffer that stores the data streams.

### CROSS REFERENCE TO RELATED PATENT APPLICATIONS

This patent application claims priority from U.S. Provisional patent application No. 61/176,494, filed on May 8, 2009, which is hereby incorporated in its entirety by reference.

### TECHNICAL FIELD

The present disclosure relates to a demodulating apparatus and method, and more particularly, to a demodulating apparatus and an associated method applied to a receiving end of a digital communication system.

### BACKGROUND OF THE PRESENT DISCLOSURE

FIG. 1 is a schematic diagram of a Digital Video Broadcasting (DVB) system. A transmitter 150 comprises an encoder 100 and a modulator 110, and a receiver 160 comprises a demodulator 120 and a video decoder 130. The DVB system is inputted with a plurality of digital data streams, each of which is transmitted via a physical layer pipe (PLP) in the form of packets each comprising 188 bytes. For example, encoded transport streams TS0, TS1 and TS2 represent different program channels. In a European Digital Video Broadcasting over Terrestrial 2 (DVB-T2) system, the modulator 110 divides the transport streams TS0, TS1 and TS2 into data streams data_PLP0, data_PLP1, data_PLP2, and common_PLP. Data stream common_PLP comprises common data packets commonly contained in the transports TS0, TS1 and TS2. Except for the common data packets and null packets, data streams data_PLP0, data_PLP1 and data_PLP2 are data packets in the transport streams TS0, TS1 and TS2, respectively. Combining all the common data packets from different data streams as one data packet common_PLP for transmitting saves bandwidth occupied by repetitive transmission of the same data packets. A desired channel to be viewed is selected at the receiving end, e.g., the selected channel corresponds to the transport stream TS0. Accordingly, the demodulator 120 in the receiver 160 combines the data stream data_PLP0 corresponding to the transport stream TS0 with the data stream common_PLP0, so as to reconstruct a transport stream TS0′ compliant to the Motion Picture Expert Group-2 (MPEG-2) specification to the video decoder 130.

Therefore, an apparatus for demodulating a digital video signal capable of reducing cost for the demodulation is in need.

### SUMMARY OF THE PRESENT DISCLOSURE

According to an embodiment of the present disclosure, an apparatus is provided for demodulating a digital video signal, applied to a receiving end of an Orthogonal Frequency-Division Multiplexing (OFDM) communication system which receives a plurality of OFDM symbols. The apparatus for demodulating a digital video signal is coupled to an external memory for storing a plurality of data sequence, and comprises a de-interleaver, a decoder, a reconstruction apparatus, and a memory interface unit (MIU). The de-interleaver de-interleaves the plurality of data sequence to generate a plurality of de-interleaved data sequence. The decoder, coupled to the de-interleaver, generates a plurality of data streams according to the plurality of de-interleaved data sequence. The reconstruction apparatus, coupled to the decoder, reconstructs the transport streams from the plurality of data streams. The MIU, coupled to the external memory, accesses the plurality of data sequence and the data streams from the external memory that comprises a de-interleaving buffer and a data reconstructing buffer. The de-interleaving buffer stores the plurality of data sequence, and the data reconstructing buffer stores the plurality of data streams.

According to another embodiment of the present disclosure, a method for demodulating a digital video signal, applied to a receiving end of an OFDM communication system, is provided. The method for demodulating a digital video signal comprises storing a plurality of data sequence into a de-interleaving buffer of an external memory; accessing and de-interleaving the plurality of data sequence from the de-interleaving buffer to generate a plurality of de-interleaved data sequence; decoding the plurality of de-interleaved data sequence to generate a plurality of data streams to be stored into a data reconstructing buffer of the external memory; and accessing and reconstructing the plurality of data streams from the data reconstructing buffer to output a transport stream.

### BRIEF DESCRIPTION OF THE DRAWINGS

FIG. 1 is a schematic diagram of a DVB system.

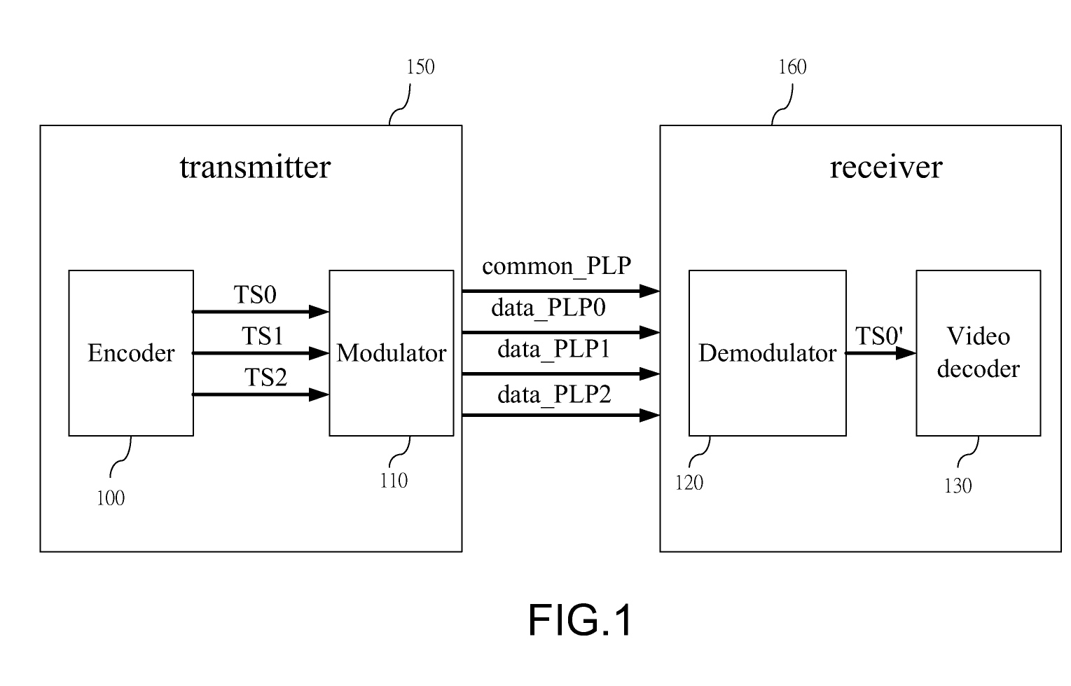

FIG. 2 is a block diagram of a de-interleaving apparatus.

FIG. 3 is a schematic diagram of a de-interleaving block.

FIG. 4 is a block diagram of a de-interleaving apparatus in accordance with an embodiment of the present disclosure.

FIG. 5 is a schematic diagram of a de-interleaving block in accordance with an embodiment of the present disclosure.

FIG. 6 is a block diagram of a demodulating apparatus in accordance with an embodiment of the present disclosure.

FIG. 7 is a flow chart of a demodulating method in accordance with an embodiment of the present disclosure.

### DETAILED DESCRIPTION OF THE PREFERRED EMBODIMENT

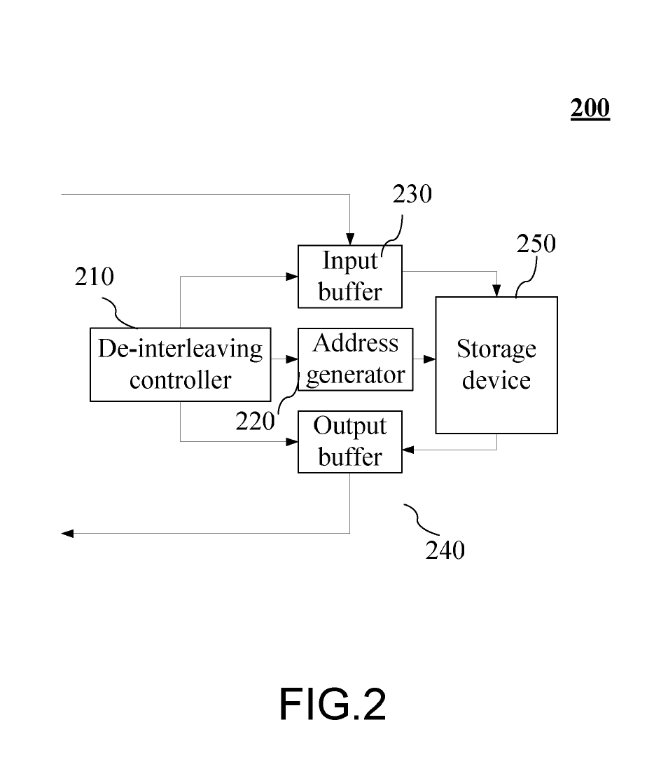

FIG. 2 is a block diagram of a de-interleaving apparatus 200 comprising a de-interleaving controller 210, an address generator 220, an input buffer 230, an output buffer 240, and a storage device 250. The input buffer 230 temporarily stores an input data sequence, and the de-interleaving controller 210 writes data temporarily stored in the input buffer 230 in sequence into the first storage device 250. The de-interleaving controller 210 accesses data in the storage device 250 according to addresses indicated by the address generator 220 based on a de-interleaving sequence. Then the accessed data are temporarily stored into the output buffer 240, and, at last, the output buffer 240 outputs the data in sequence to generate a de-interleaved data sequence.

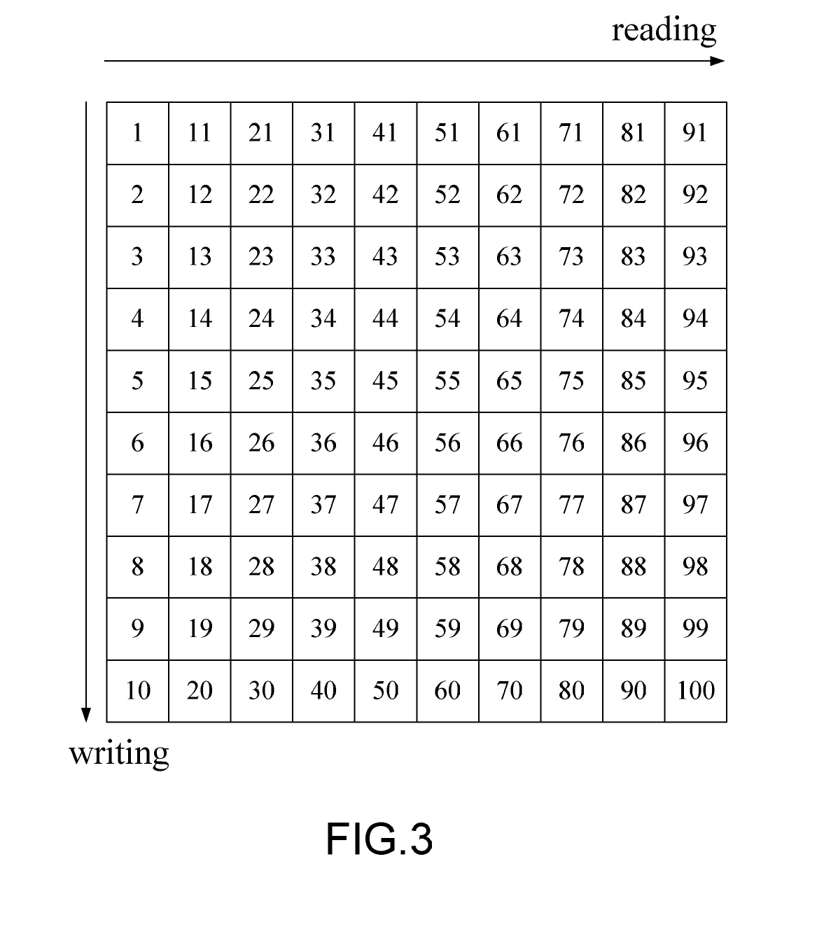

FIG. 3 is a schematic diagram of a de-interleaving block comprising one hundred data to be de-interleaved. Numerals of the data in FIG. 3 represent corresponding sequence of writing data to addresses of first storage device. That is, data 1, 2, 3 . . . to 100 are respectively written in sequence to the corresponding memory addresses 1, 2, 3 . . . to 100. As observed from the de-interleaving table shown in FIG. 3, the data is firstly written vertically from top to bottom and then horizontally from left to right. For example, when outputting a de-interleaved data sequence, the first storage device accesses the data in a sequence of the numerals 1, 11, 21, . . . , 91, 2, 12, . . . , 92, 3, 13, . . . , etc. From the de-interleaving table, the data is firstly read horizontally from left to right, then vertically from top to bottom. Therefore, the de-interleaved data sequence can only be fully accessed when all of the data of the de-interleaving block is written into the first storage device. When the de-interleaving block is large, the storage device with a rather large capacity is needed. If the applied storage device is a built-in static random access memory (SRAM), the integrated circuit area and costs will largely increase. If the applied storage device is a dynamic random access memory (DRAM), although the cost is lower, access time is longer because access of de-interleaved data sequence needs consecutive access of addresses of different memory banks; as a result, it takes up more MIU bus bandwidth. For example, if addresses 1, 11, 21 belong to different memory banks, the larger the de-interleaving block is, the more possible that it needs to cross access addresses in different memory banks. Because the DVB-T2 system to which the de-interleaving apparatus usually applies transmits high definition (HD) video signals with large data transmission rate, there is a need for a demodulating apparatus with lower costs as well as higher access efficiency.

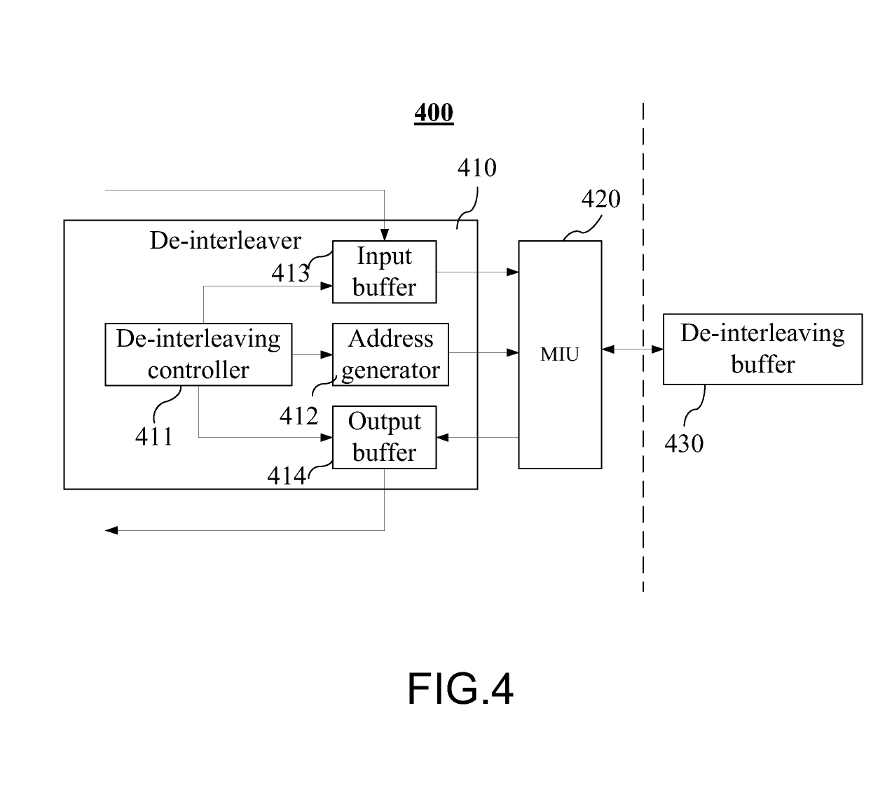

FIG. 4 is a block diagram of a de-interleaving apparatus 400 in accordance with an embodiment of the present disclosure. The de-interleaving apparatus 400 comprises a de-interleaver 410 and a memory interface unit (MIU) 420. De-interleaving buffer 430 is coupled to the de-interleaving apparatus 400 from outside and may be realized by an external memory, such as a DRAM. The de-interleaver 410 is connected to MIU 420. The de-interleaver 410 writes an input data sequence to the de-interleaving buffer 430 via the MIU 420, and accesses data from the de-interleaving buffer 430 via the MIU 420 to generate a de-interleaved data sequence. The de-interleaver 410 comprises a de-interleaving controller 411, an address generator 412, an input buffer 413 and an output buffer 414. The input data sequence is temporarily stored into the input buffer 413, and the de-interleaving controller 411 then controls the data sequence in the buffer 413 to write into the de-interleaving buffer 430 via the MIU 420. The de-interleaving controller 411 utilizes the addresses generated by the address generator 412 based on a de-interleaving sequence, to access data stored at the corresponding addresses in the de-interleaving buffer 430, via MIU 420, in order to store in the output buffer 414. The de-interleaving controller 411 then sequentially outputs the data in the output data buffer 414 to generate a de-interleaved data sequence. Preferably, the input buffer 413 and the output buffer 414 may be realized by a first-in-first-out (FIFO) structure.

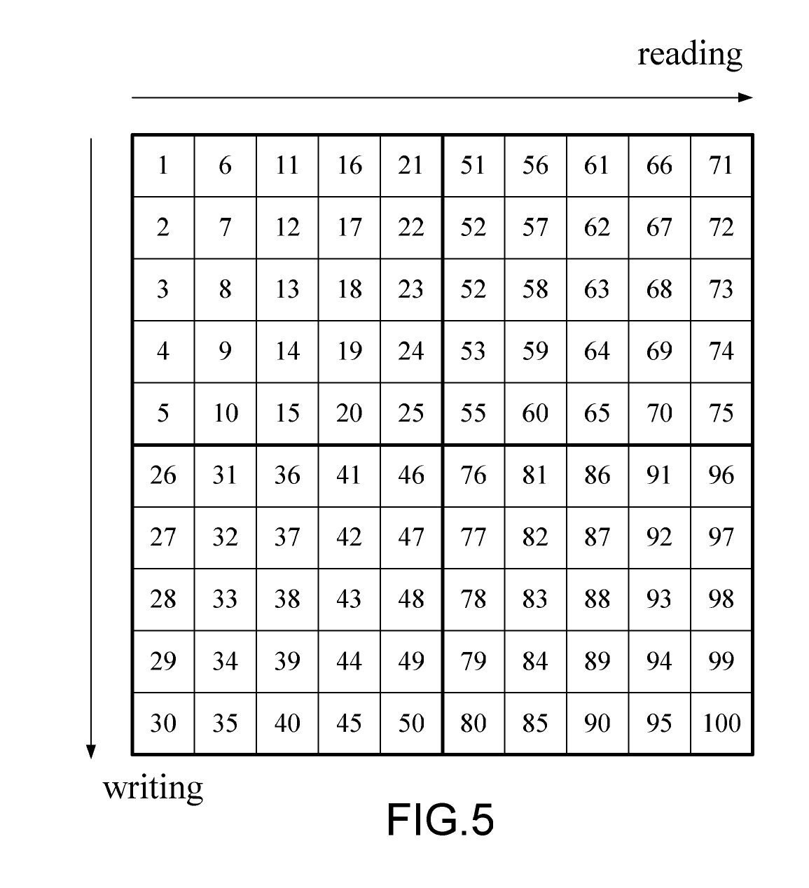

FIG. 5 is a schematic diagram of a de-interleaving block in a tile mode in accordance with an embodiment of the present disclosure. For example, a de-interleaving block comprises one hundred data to be de-interleaved. Numerals of the data in FIG. 5 represent a corresponding sequence of writing data to addresses of a first storage device. For example, the input data are respectively written into the first storage device to addresses 1, 2, . . . , 5, 26, 27, . . . , 30, 6, . . . , 10, 31, . . . , 35, 11, . . . , 99, 100 in sequence; i.e., as observed from the de-interleaving block, the data is firstly written vertically from top to bottom and then horizontally from left to right. When the de-interleaving block is accessed to output a de-interleaved data sequence, data stored at addresses 1, 6, . . . , 21, 51, . . . , 71, 2, 7, . . . , 22, 52, . . . , 72, 3, . . . , 95, 100 is accessed in sequence, i.e., the data is accessed firstly horizontally from left to right and then vertically from top to bottom. Referring to FIG. 5, the data of the de-interleaving block stored in the de-interleaving buffer at addresses that are divided into four sub-blocks with consecutive addresses, i.e., the de-interleaving block is in the tile mode. Accordingly, when the data is to be accessed, adjacent data within each of the sub-blocks is consecutively accessed in one burst mode cycle to reduce the possibility of accessing different memory banks, so as to reduce the access time and the occupied bus bandwidth. For example, five data at addresses 1, 6, 11, 16, and 21 are consecutively accessed in one burst mode cycle, and five data at addresses 51, 56, 61, 66, and 71 are then accessed in a next burst mode cycle. As observed from the foregoing description, when five data at consecutive addresses 1, 6, 11, 16, and 21 are accessed, using the data arrangement of the tile mode, distances between the consecutive addresses of 1, 6, 11, 16, and 21 are smaller than those of non-consecutive addresses, so that the burst mode of the de-interleaving block can be realized. Supposing that the addresses 21 and 51 belong to different memory banks, data stored at the addresses 21 and 51 are accessed in different burst mode cycles so it reduces waste of memory access rate. Likewise, when data is to be written into the de-interleaving buffer, data is consecutively written into addresses 1, 2, 3, 4 and 5 in one burst mode cycle, and is consecutively written into addresses 26, 27, 28, 29 and 30 in a next burst mode cycle. Accordingly, efficiency of accessing the memory banks is increased by writing the data into addresses 5 and 26 in different burst mode cycles.

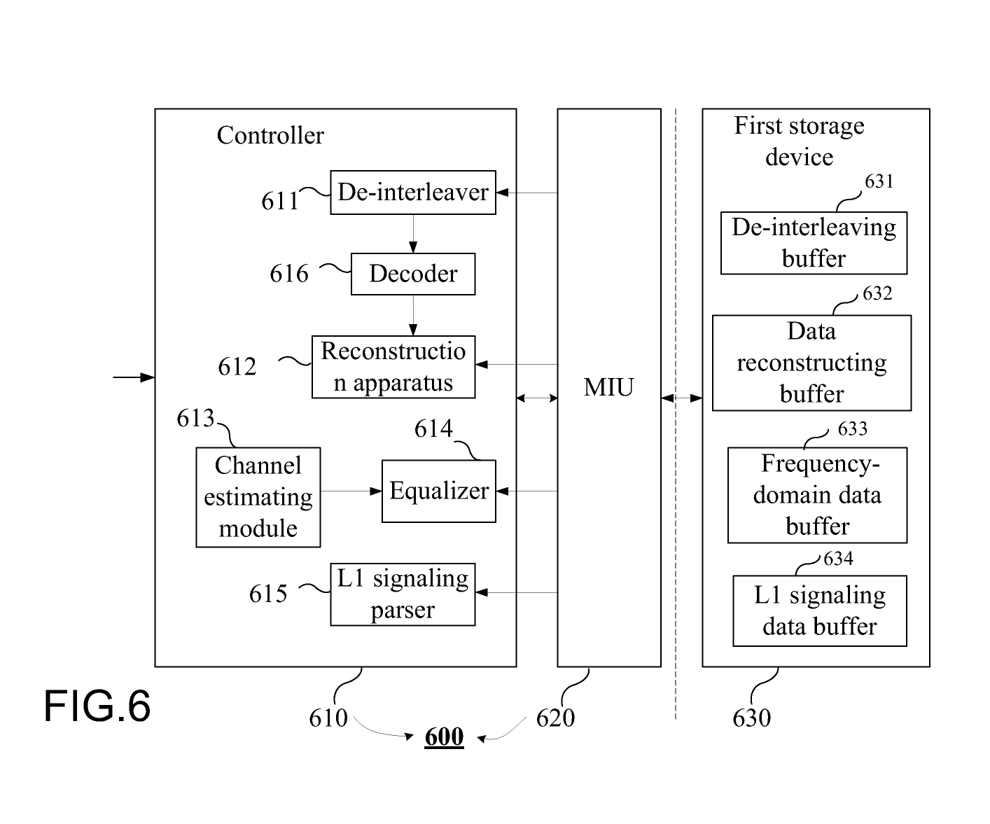

FIG. 6 is a block diagram of a demodulating apparatus 600 in accordance with an embodiment of the present disclosure. The demodulating apparatus 600 comprises a controller 610 and an MIU 620. First storage device 630 is an external memory disposed outside the demodulating apparatus 600. The first storage device 630 is coupled to the controller 610 via the MIU 620. The controller 610 and the MIU 620 are connected and may be integrated to an integrated circuit, and the first storage device 630 can be realized by a DRAM. Data reading and writing between the controller 610 and the first storage device 630 are processed via the MIU 620. In this embodiment, the controller 610 comprises a de-interleaver 611, a reconstruction apparatus 612, a channel estimating module 613, an equalizer 614, a layer 1 (L1) signaling parser 615 and a decoder 616. The first storage device 630 comprises a de-interleaving buffer 631, a data reconstructing buffer 632, a frequency-domain data buffer 631, and an L1 signaling data buffer 634. The de-interleaver 611 restores an interleaved data sequence to a de-interleaved data sequence according to a de-interleaving sequence. More specifically, the de-interleaver 611 first stores the interleaved data sequence to the de-interleaving buffer 631 via the MIU 620, and then accesses those data according to the de-interleaving sequence via the MIU 620 to form the de-interleaved data sequence. Preferably, implementing a tile mode and burst mode to de-interleave the interleaved data sequence can minimize access time, and thus other modules in the controller 610 have more time in between different burst modes to access data in the first storage device 630. It is to be noted that, in applications of the DVB-T2 system, for example, the de-interleaver 611 comprises a time de-interleaver and a cell de-interleaver. The time de-interleaver de-interleaves data sequence to a time de-interleaved data sequence to store in a second storage device, e.g., a built-in SRAM (also please refer to the input buffer 413 or the output buffer 414 in FIG. 4, or other memory set in the controller); the cell de-interleaver de-interleaves the time-de-interleaved data sequence to generate a de-interleaved data sequence. The foregoing embodiments of de-interleaver are suitable for the time de-interleaver. In one of the embodiments, the cell de-interleaver randomly accesses the time de-interleaved data sequence in order to form the de-interleaved data sequence. Therefore, the time de-interleaved data sequence preferably stores in an SRAM to effectively realize large-amount of random access.

The decoder 616 decodes the de-interleaved data sequence generated by the de-interleaver 611 into a data stream; then the data stream stores into the data reconstructing buffer 632 for later reconstruction by the reconstruction apparatus 612. Preferably, read and write sequence adopts FIFO structure. and the reconstruction apparatus 612 accesses the data stream stored in the data reconstructing buffer 632 via the MIU 620 to reconstruct the transport stream from the data stream and accurately obtain a bit rate.

The L1 signaling data buffer 634 is for storing L1 signaling data. In a DVB-T2 system, data is transmitted in the form of frames. Each of the frames comprises a L1 signaling data at its start position, for informing a receiving end of parameters and information needed for retrieving T2 frames. For example, the data modulation adopts Fast Fourier Transform (FFT) mode, or the system is a single-input-single-output (SISO) structure or a multiple-input-signal-output (MISO) structure. Therefore, when a receiver receives a digital data stream compliant to the DVB-T2 specification, an L1 signaling data first needs to be retrieved from the digital data stream, which is then accurately de-modulated after information of the L1 signaling data is accessed. The L1 signaling parser 615 accesses the L1 signaling data from the L1 signaling data buffer 634 via the MIU 620, parses the information and transmits to modules the parsed information and parameters of the L1 signaling data that are needed for demodulation.

In a wireless communication system, inter-symbol interference (ISI) between received signals is usually caused by a multipath fading effect in a radio channel. To remove the ISI, a receiver is provided with an equalizer that needs information of channel impulse response (CIR) to operate, and therefore estimation of the CIR plays a critical part in a mobile radio system. In an OFDM system, data symbols are analyzed according to pilot symbols acknowledged in advance in a transmitter and the receiver in the estimation of the CIR. Each of the pilot symbols is carried by a pilot sub-carrier, and each of the data symbols is carried by a data sub-carrier. For example, in the OFDM system, the estimation of the CIR is commonly achieved by calculation of the least difference of the square of a frequency-domain transmitting value and the square of a frequency-domain receiving value of a pilot symbol at a position of each of the pilot sub-carriers. Relation of the frequency-domain transmitting value and the frequency-domain receiving value is represented by equation Y(k)=H(k)X(k)+Nₖ, where Y(k) represents a signal received by the receiver, X(k) represents a signal received by the transmitter, H(k) represents a channel frequency response in channel k, and Nₖ represents noises. In an OFDM channel, data transmitted via pilot sub-carriers X(k) is known, and data transmitted X(k) via data sub-carriers is unknown. Accordingly. H(k) corresponding to a pilot symbol is first obtained from

$$H ( k ) = \frac{Y ( k )}{X ( k )}$$

(i.e., the noises Nₖ are omitted). Channel impulse responses H(k) corresponding to other data sub-carriers are estimated according to channel estimation. Therefore, when the channel impulse response H(k) is obtained, data transmitted via the data sub-carriers X(k) is calculated as

$$X ( k ) = \frac{Y ( k )}{H ( k )} .$$

The OFDM symbols, comprising a plurality of data symbols and pilot symbols, stored and received by the frequency-domain data buffer 633, are accessed according to an FIFO structure. The channel estimating module 613 generates a channel response H(k) to the equalizer 614 according to the known pilot symbols of the received OFDM symbols. The equalizer 614 accesses the data symbols of the OFDM symbols via the MIU 620 to equalize information contained in the data symbols according to the frequency channel response H(k), i.e.,

$$X ( k ) = \frac{Y ( k )}{H ( k )} .$$

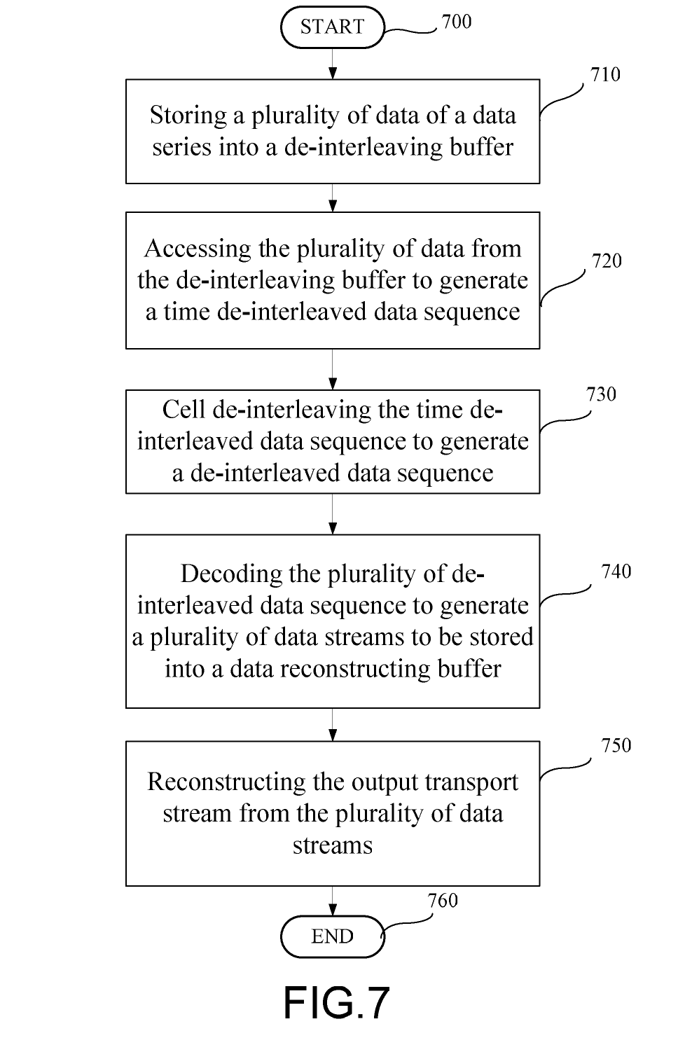

FIG. 7 is a flow chart of a demodulating method, applied to a receiving end of a DVB-T2 system, in accordance with an embodiment of the present disclosure. The demodulating method begins with Step 700. In Step 710, storing a plurality of data of a data sequence into a de-interleaving buffer located in a first storage device, e.g., an external memory realized by a DRAM. Preferably, the step is performed by storing the plurality of data of the data sequence into the de-interleaving buffer in tile mode. In Step 720, accessing the plurality of data sequence from the de-interleaving buffer by burst mode to access addresses of consecutive blocks in the tile mode to generate a time de-interleaved data sequence, and storing the time de-interleaved data sequence into a second storage device, e.g., a built in memory such as SRAM. In Step 730, cell de-interleaving the time de-interleaved data sequence to generate a de-interleaved data sequence. It is to be noted that, in step 730, because the time de-interleaved data sequence is randomly accessed; tile mode does not apply to cell de-interleaving step. Preferably, the time de-interleaved data sequence stores into an SRAM. In Step 740, decoding the plurality of de-interleaved data sequence to generate a plurality of data streams to store into a data reconstructing buffer of the first storage device, such as an external memory. In Step 750, reconstructing an output transport stream from the plurality of data streams accessed from the data reconstructing buffer. The flow ends in Step 760. Since the plurality of data are written into the de-interleaving buffer via the tile mode, access of the plurality of data stored in the de-interleaving buffer is effectively achieved via the tile mode and the burst mode. In this embodiment, an L1 signaling data is stored into an L1 signaling data buffer of the external memory, and is accessed from the L1 signaling data buffer during intervals of burst mode cycles to parse information of the L1 signaling data. Alternatively, received OFDM symbols are stored into a frequency-domain data buffer with an FIFO structure of the external memory, and channel estimation is performed according to the OFDM symbols to generate frequency-domain channel responses. After that, the OFDM symbols are accessed from the frequency-domain data buffer during intervals of burst mode cycles to equalize the OFDM symbols according to the frequency-domain channel responses.

A structure of de-interleaving with tile mode and a linear access of memory is provided according to the present disclosure, so that it is possible to demodulate digital video signals utilizing external memories in order to reduce bus bandwidth as well as area and cost of integrated chips. For example, supposing that the first storage device realized by a synchronous dynamic random access memory (SDRAM) provides 1 bit per 1 MHz. Data reading and writing between a de-interleaver and a de-interleaving buffer bandwidth occupancy is 9.1429 MHz, an L1 signaling data buffer has bandwidth of 9.1429 MHz, data reading of a frequency-domain data buffer occupies bandwidth of 12 MHz, data writing of the frequency-domain data buffer occupies a bandwidth of 9.1429 MHz, and data reading and writing in reconstructing buffer both occupy 2.5 MHz. Supposing that a bus usage ratio is 0.8, in this embodiment, a 32-bit SDRAM needs to offer a bandwidth of at least 78.393 ((9.1429*5+12+2.5*2)/0.8) MHz to achieve the above-mentioned structure. Accordingly, through the techniques of the foregoing embodiment, the SDRAM is capable of realizing the embodiments according to the present disclosure.

In conclusion, an apparatus for demodulating a digital video signal applied to a receiving end of an OFDM communication that receives a plurality of OFDM symbols is provided by the present disclosure. The apparatus is coupled to an external memory for storing a plurality of data sequences, and comprises a de-interleaver, a decoder, a reconstruction apparatus, and an MIU. The de-interleaver de-interleaves the plurality of data sequences to generate a plurality of de-interleaved data sequences. The decoder, coupled to the de-interleaver, generates a plurality of data streams. The reconstruction apparatus, coupled to the decoder, reconstructs the transport stream from the data streams. The MIU, coupled to the external memory, accesses the plurality of data sequences and the data streams from the external memory comprising a de-interleaving buffer and a data reconstructing buffer. The de-interleaving buffer stores the plurality of data sequences, and the reconstructing buffer stores the plurality of data streams.

A demodulating method of a digital video signal applied to a receiving end of an OFDM communication system is provided by the present disclosure. The method comprises storing a plurality of data sequences into a de-interleaving buffer of a DRAM; accessing and de-interleaving the plurality of data sequences from the de-interleaving buffer to generate a plurality of de-interleaved data sequences; decoding the de-interleaved data sequence to generate a plurality of data streams to be stored in a data reconstructing buffer of the DRAM; and a reconstructing the output transport stream from the plurality of data streams from the data reconstructing buffer.

While the present disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for demodulating a digital video signal, applied to a receiving end of an Orthogonal Frequency-Division Multiplexing (OFDM) communication system, where a first storage device storing a plurality of data sequences is coupled to the apparatus, the apparatus comprising:
a controller, comprising:
a de-interleaver, that de-interleaves the plurality of data sequences to generate a plurality of de-interleaved data sequences;
a decoder, coupled to the de-interleaver, that generates a plurality of data streams according to the de-interleaved data sequences; and
a reconstruction apparatus, coupled to the decoder, that reconstructs a transport stream from the plurality of data streams; and
a memory interface unit, coupled to the controller, that accesses the plurality of data sequences and the data streams from the first storage device.

2. The apparatus as claimed in claim 1, wherein the first storage device comprises a de-interleaving buffer that stores the plurality of data sequences, and a data reconstructing buffer that stores the plurality of data streams.

3. The apparatus as claimed in claim 2, wherein the data reconstructing buffer comprises a first-in-first-out (FIFO) structure.

4. The apparatus as claimed in claim 1, wherein the de-interleaver comprises a time de-interleaver and a cell de-interleaver.

5. The apparatus as claimed in claim 4, wherein the time de-interleaver de-interleaves the plurality of data sequences via a tile mode and generates a plurality of time de-interleaved data sequences.

6. The apparatus as claimed in claim 5, wherein the controller further comprises a second storage device that stores the plurality of time de-interleaved data sequences.

7. The apparatus as claimed in claim 5, wherein the cell de-interleaver de-interleaves the plurality of time de-interleaved data sequences and generates the de-interleaved data sequences.

8. The apparatus as claimed in claim 1, wherein the OFDM communication system receives a plurality of OFDM symbols, the apparatus further comprising a channel estimation module, that generates a plurality of channel frequency responses according to the plurality of OFDM symbols.

9. The apparatus as claimed in claim 1, further comprising:
an equalizer, coupled to the channel estimation module, that accesses the plurality of OFDM symbols stored in a frequency-domain data buffer of the first storage device, and equalizes the plurality of OFDM symbols according to the channel frequency responses.

10. The apparatus as claimed in claim 1, further comprising a layer 1 (L1) signaling parser, coupled to the memory interface unit, that parses a plurality of L1 signaling data accessed from the first storage device.

11. A method for demodulating a digital video signal, applied to a receiving end of an Orthogonal Frequency-Division Multiplexing (OFDM) communication system, the method comprising:
storing a plurality of data sequences into a de-interleaving buffer located in a first storage device coupled to a controller;
accessing by the controller the plurality of data sequences from the de-interleaving buffer;
de-interleaving the plurality of data sequences to generate a plurality of de-interleaved data sequences;
decoding the plurality of de-interleaved data sequences to generate a plurality of data streams;
storing the data streams into a data reconstructing buffer in the first storage device; and
reconstructing an output transport stream from the plurality of data streams.

12. The method as claimed in claim 11, wherein generating the de-interleaved data sequence comprises:
time de-interleaving the plurality of data sequences to generate a plurality of time de-interleaved data sequences that are stored into a second storage device in the controller; and
cell de-interleaving the plurality of time de-interleaved data sequences to generate the plurality of de-interleaved data sequences.

13. The method as claimed in claim 11 wherein storing the plurality of data sequences comprises storing the plurality of data sequences into the de-interleaving buffer via a tile mode.

14. The method as claimed in claim 13, wherein generating the plurality of time de-interleaved data sequences comprises accessing the plurality of data sequences via the tile mode and a burst mode to generate the plurality of time de-interleaved data sequence.

15. The method as claimed in claim 14, further comprising:
storing a plurality of OFDM symbols into a frequency-domain data buffer of the external memory;
performing channel estimation according to the plurality of OFDM symbols to generate a plurality of channel frequency responses;
accessing the plurality of OFDM symbols from the frequency-domain data buffer; and
equalizing the plurality of OFDM symbols according to the channel frequency responses.

16. The method as claimed in claim 15, wherein the plurality of OFDM symbols are accessed from the frequency-domain data buffer via a first-in-first-out (FIFO) structure.

17. The method as claimed in claim 11, further comprising:
storing a plurality of L1 signaling data into an L1 signaling data buffer of the first storage device;
accessing the plurality of L1 signaling data from the L1 signaling data buffer; and
parsing the plurality of L1 signaling data.
